(19) United States
(12) Patent Application Publication
(10) Pub. No.: US 2018/0301672 A1
(43) Pub. Date: Oct. 18, 2018

(54) SEALING BODY FOR CYLINDRICAL BATTERIES, AND CYLINDRICAL BATTERY USING SAME

(71) Applicant: Panasonic Intellectual Property Management Co., Ltd., Osaka (JP)

(72) Inventors: SEIICHI AOKI, Osaka (JP); KOKI INOUE, Osaka (JP); TOMIYUKI TAGA, Osaka (JP)

(73) Assignee: Panasonic Intellectual Property Management Co., Ltd., Osaka (JP)

(21) Appl. No.: 15/766,371

(22) PCT Filed: Oct. 13, 2016
(86) PCT No.: PCT/JP2016/004564

§ 371 Date: Apr. 6, 2018

(30) Foreign Application Priority Data
Oct. 30, 2015 (JP) 2015-214553

(51) Int. Cl. H01M 2/04; H01M 2/30; H01M 10/058; H01M 10/04

(52) U.S. Cl. CPC H01M 2/0486; H01M 2/046; H01M 10/0422; H01M 10/058; H01M 2/30

(57) ABSTRACT

A sealing body for cylindrical batteries includes a clad material that has a first surface and a second surface opposite to the first surface. The clad material includes a first metal layer made of a first metal on the first surface side, and a second metal layer made of a second metal on the second surface side. The clad material is formed so as to include a central portion having a projecting terminal portion, and a collar portion disposed on a rim of the central portion integrally with the central portion. The clad material includes the terminal portion on the first surface side, and a lead welding surface on the second surface side. The first metal has a rigidity higher than that of the second metal.

### PRIORITY

This application is a U.S. National stage application of International Application PCT/JP2016/004564, with an international filing date of Oct. 13, 2016, which claims priority to Japanese Patent Application No. 2015-214553 filed on Oct. 30, 2015. The entire disclosures of International Application PCT/JP2016/004564 and Japanese Patent Application No. 2015-214553 are hereby incorporated herein by reference.

### TECHNICAL FIELD

The present invention relates to a sealing body for cylindrical batteries that is molded integrally with a terminal portion, and a cylindrical battery using the sealing body.

### BACKGROUND ART

In a cylindrical battery, a sealing body blocks an opening of a bottomed cylindrical battery case, and generally has a plate shape. Generally, the sealing body includes an explosion proof mechanism such as a safety valve, and has a projecting cap-shaped terminal portion on its surface.

Patent Literature 1 discloses a cylindrical non-aqueous electrolyte battery using a plate-shaped sealing body. The sealing body has two holes, and a positive electrode terminal and a negative electrode terminal are attached to respective holes via insulating packing. In Patent Literature 2, a non-aqueous electrolyte secondary battery employs a plate-shaped sealing body that includes a terminal cap having a gas vent hole.

### CITATION LIST

### Patent Literature

PTL 1: Unexamined Japanese Patent Publication No. 2000-149884

PTL 2: Unexamined Japanese Patent Publication No. 2005-276458

### SUMMARY OF THE INVENTION

In Patent Literature 1 and Patent Literature 2, a terminal portion attached to a sealing body has a complicated structure. However, in a cylindrical battery whose outer diameter is 10 mm or less, for example, the sealing body does not necessarily need to have such a complicated structure. The battery is sealed by disposing the sealing body on an opening in a battery case and caulking and sealing them. A lead pulled out of an electrode is welded to the sealing body. When the sealing body is made of a material to which a lead is easily welded, the sealing body becomes deformed during the caulking and sealing.

The objective of the present disclosure is to provide a sealing body for cylindrical batteries that has a simple structure, has a high strength, and allows easy welding of the lead, and to provide a cylindrical battery using the sealing body.

One aspect of the present disclosure relates to a sealing body for cylindrical batteries that includes a clad material having a first surface and a second surface opposite to the first surface. The clad material includes a first metal layer made of a first metal on the first surface side, and a second metal layer made of a second metal on the second surface side. The clad material is formed so as to include: a central portion having a projecting terminal portion; and a collar portion disposed on a rim of the central portion integrally with the central portion. The clad material includes the terminal portion on the first surface side, and a lead welding surface on the second surface side. The first metal has rigidity higher than that of the second metal.

Another aspect of the present disclosure relates to a cylindrical battery that includes: a bottomed cylindrical battery case having an opening; an electrode group and electrolyte that are accommodated in the battery case; and a sealing body for sealing the opening. The sealing body includes a clad material that has a first surface and a second surface opposite to the first surface. The clad material includes a first metal layer made of a first metal on the first surface side, and a second metal layer made of a second metal on the second surface side. The clad material is formed so as to include: a central portion having a projecting terminal portion; and a collar portion disposed on a rim of the central portion integrally with the central portion. The clad material includes the terminal portion on the first surface side, and a lead welding surface on the second surface side. The first metal has rigidity higher than that of the second metal.

The present disclosure can provide a sealing body for cylindrical batteries that has a simple structure, has a high strength, and allows easy welding of the lead, and provide a cylindrical battery using the sealing body.

### BRIEF DESCRIPTION OF DRAWINGS

FIG. 1 is a vertical sectional view schematically showing a sealing body for cylindrical batteries in accordance with an exemplary embodiment of the present invention.

FIG. 2 is a vertical sectional view schematically showing a cylindrical battery using the sealing body of FIG. 1.

### DESCRIPTION OF EMBODIMENT(S)

Hereinafter, an exemplary embodiment of the present invention is described in more detail with reference to the accompanying drawings appropriately as necessary.

### (Sealing Body)

A sealing body of an exemplary embodiment of the present invention is used for cylindrical batteries, and includes a clad material that has a first surface and a second surface opposite to the first surface. The clad material includes a first metal layer made of a first metal on the first surface side, and a second metal layer made of a second metal on the second surface side. The clad material is molded so as to include: a central portion having a projecting terminal portion; and a collar portion disposed on a rim of the central portion integrally with the central portion. The clad material includes the terminal portion on the first surface side, and a lead welding surface on the second surface side. The first metal has rigidity higher than that of the second metal.

A conventional cylindrical battery includes a plate-shaped sealing body, but a terminal portion having a complicated structure is attached to the sealing body. When the structures of the sealing body and terminal portion are complicated, however, the volumes occupied by them are large and hence the increase in capacity is difficult. Especially, in a small-sized battery, the volumes occupied by the sealing body and terminal portion cannot be neglected. When the sealing body is made of a material to which a lead is easily welded, the following problem can occur: in caulking and sealing the opening of the battery case and the sealing body, the sealing body becomes deformed and the sealability of the battery reduces.

In the present exemplary embodiment, as discussed above, the sealing body includes a clad material that is molded so as to include a central portion having a projecting terminal portion and a collar portion disposed integrally with the central portion. In other words, the sealing body has a simple structure in which the sealing body is integrated with the terminal portion, and can be easily downsized. Especially, when the battery has a small diameter, the sealing body hardly requires a gas vent hole. Therefore, the sealing body is appropriate for being molded integrally with the terminal portion. Since the sealing body has a simple structure, the manufacturing process can be simplified and the cost can be reduced.

The above-mentioned structure is achieved by a clad material including a first metal layer on the first surface side and a second metal layer on the second surface side. The clad material means a material that is formed by stacking the first metal layer and second metal layer, rolling them with a pressure, and thus bonding one-side surfaces of the metal layers together. The clad material includes a projecting terminal portion on the first surface side. As the first metal contained in the first metal layer on the first surface side, a metal having rigidity higher than that of the second metal contained in the second metal layer is employed. Therefore, the above-mentioned structure is easily formed, and the strength of the collar portion is easily kept. While, the second surface side serves as a lead welding surface. The first metal having a high rigidity is apt to have a high melting point, and is often difficult to be welded. Especially, when the battery has a small diameter, the lead is difficult to be welded to the first metal. The welding of the lead to the lead welding surface is made easy, by disposing, on the second surface side of the sealing body, a second metal having rigidity lower than that of the first metal.

The sealing body is obtained by molding a plate-shaped clad material including a first metal layer and a second metal layer and forming a projecting central portion and a collar portion as discussed above. Therefore, the second metal constituting the second metal layer is softer than the first metal constituting the first metal layer. The hardness of such a metal can be evaluated using rigidity (namely, Young's modulus).

Preferably, Young's modulus Y₂ of the second metal is 100 GPa or less or 80 GPa or less, for example. Young's modulus Y₁ of the first metal is higher than Young's modulus Y₂ of the second metal. Difference Y₁-Y₂ between the Young's moduluses is for example 20 GPa or more, preferably 40 GPa or more, or may be 100 GPa or more. When Young's modulus Y₂ and/or the Young's modulus difference are within such ranges, a high strength of the collar portion and a high weldability of the lead are further easily kept.

An example of the first metal includes a simple metal or alloy containing at least one metal selected from a group consisting of nickel, iron, and copper. The alloy may contain a metal other than these metals. The alloy contains stainless steel or brass. As the first metal, nickel, iron, stainless steel, copper, or brass is preferable.

An example of the second metal includes a simple metal or alloy containing at least one metal selected from a group consisting of aluminum and silver. The alloy may contain a metal other than these metals. Using a second metal having a high electrical conductivity such as aluminum, silver, or an alloy of them is advantageous from the viewpoint of reducing the resistance of the sealing body. From the viewpoint of the weldability, electrical conductivity, and/or cost, aluminum or an aluminum alloy is preferable as the second metal.

In the sealing body, the shape of the terminal portion is not particularly limited as long as the shape is a projecting shape, but is generally a columnar shape. Therefore, the sealing body has a shape like a hat when viewed from a side surface. The average diameter of the outer periphery of the terminal portion is for example 1.0 to 6.0 mm inclusive, or may be 0.5 to 8.0 mm inclusive. When the average diameter of the outer periphery of the terminal portion is within such a range, the surface area required for soldering or welding is easily kept during secondary processing.

Preferably, thickness (t_{c2}) of the second metal layer in the central portion is greater than thickness (t_{b2}) of the second metal layer in the collar portion. The smallness of thickness t_{b2} allows the strength of the collar portion to be easily kept, so that the deformation of the collar portion during the caulking and sealing can be suppressed, and the battery is easily sealed. In addition, the sealability is easily kept, so that the leak of the electrolyte can be suppressed. Furthermore, largeness of thickness t_{c2} allows the sealing body itself to be easily processed.

When the thickness of the second metal layer has the above-mentioned relationship between the central portion and the collar portion, it is preferable that the second metal has a melting point and/or resistivity lower than those of the first metal. When the melting point of the second metal is lower than that of the first metal, the sealing body is easily formed and the weldability of the lead to the sealing body is further increased. When the resistivity of the second metal is lower than that of the first metal, the resistance of the sealing body is advantageously reduced.

The proportion (=t_{c2}/T_{c}×100) of thickness t_{c2} of the second metal layer in the central portion to thickness (T_{c}) of the central portion is preferably 30 to 95% inclusive, more preferably 50 to 95% inclusive. Especially, it is preferable that thickness t_{c2} of the second metal layer in the central portion is greater than thickness t_{c1} of the first metal layer in the central portion. When the proportion of the thickness of the second metal layer in the central portion is within such a range, especially, using a second metal having a high electrical conductivity can further reduce the resistance of the sealing body.

The proportion (=t_{b2}/T_{b}×100) of thickness t_{b2} of the second metal layer in the collar portion to thickness (T_{b}) of the collar portion is preferably 5 to 70% inclusive, more preferably 5 to 50% inclusive. When the proportion of the thickness of the second metal layer in the collar portion is within such a range, the thickness of the first metal layer having a high rigidity can be kept to some extent. Therefore, when the sealing body is attached to the opening of the battery case by caulking, the deformation of the sealing body due to stress can be suppressed, and the leak of the electrolyte can be suppressed.

The thickness of the central portion is for example 0.5 to 2.0 mm inclusive, preferably 0.7 to 1.5 mm inclusive. When the thickness of the central portion is within such a range, the volume occupied by the sealing body is easily reduced while the sealability of the battery is kept. The thickness of the collar portion is for example 0.2 to 0.6 mm inclusive, preferably 0.2 to 0.5 mm inclusive. When the thickness of the collar portion is within such a range, the opening of the battery case and the sealing body are easily sealed. Furthermore, when gas is generated in the battery to increase the battery inner pressure, the sealing body comes off and the gas is easily vented.

The sealing body includes a terminal portion on the first surface side. The terminal portion is exposed to the outside of the battery. Therefore, when the first surface side including a surface layer of the terminal portion is made of the first metal layer having a high rigidity, the deformation of the terminal portion can be suppressed.

The sealing body includes a lead welding surface on the second surface side. The second surface may have a projecting surface or a recessed surface. From the viewpoint of easily welding the lead, however, the second surface needs to be a flat surface or a projecting surface. It is desired that the projecting surface is flat. Especially, in a small-sized battery in which the welding of the lead is difficult, it is preferable that the second surface is a flat surface because the weldability of the lead to the sealing body is increased. On the vertical cross section that cuts the central portion of the sealing body, when the flat surface is regarded to have a circular arc shape, radius R of the circular arc is preferably 3 mm or more, more preferably 40 mm or more. As radius R is increased, the surface becomes flatter.

In a sealing body used for a battery having a small diameter, the average diameter of the outer periphery of the collar portion is for example 5.0 mm or less, or sometimes 3.0 mm or less. Even in a battery including such a small-sized sealing body, the above-mentioned structure of the sealing body allows the strength of the collar portion and a high weldability of the lead to be kept. This structure is advantageous from the viewpoint of increasing the capacity of the battery.

The sealing body may be plated (for example, nickel plating) as necessary.

The sealing body can be made and molded by header processing (cold heading processing). Specifically, the sealing body is obtained in the following processes:
a plate-shaped clad material including a first metal layer and a second metal layer is disposed in a die having a shape corresponding to the central portion and collar portion so that the first surface of the first metal layer comes into contact with the die; and
the clad material is molded so as to be pressed into the die.
   In the used plate-shaped clad material, each of the thickness of the first metal layer and the thickness of the second metal layer is relatively uniform in the whole clad material. By molding the clad material so as to press it into the die, the second metal layer of the clad material disposed in an area corresponding to the collar portion in the die is shifted to an area corresponding to the central portion in the die. Thus, the central portion having the above-mentioned projecting shape and the collar portion are formed. Therefore, the thickness of the second metal layer in the central portion is apt to increase. Conventionally, it is difficult to form a sealing body in the state where the second surface side of the central portion is buried. In the present exemplary embodiment, however, it is found that a sealing body having the above-mentioned structure can be easily produced using a clad material in the above-mentioned method.

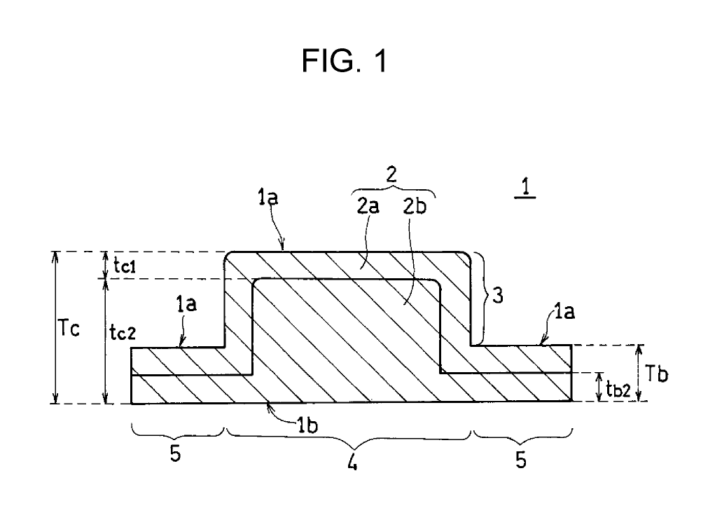

FIG. 1 is a vertical sectional view schematically showing a sealing body in accordance with the present exemplary embodiment. Sealing body 1 is made of clad material 2 that has first surface 1a and second surface 1b opposite to the first surface. Clad material 2 includes first metal layer 2a on the first surface 1a side, and second metal layer 2b on the second surface 1b side. Clad material 2 has a shape like a hat. More specifically, clad material 2 is molded so as to include central portion 4 and collar portion 5 that is disposed on a rim of central portion 4. Central portion 4 has terminal portion 3 having a projecting shape on the first surface side. Collar portion 5 is disposed on the rim of central portion 4 integrally with central portion 4. Second surface 1b of the clad material (especially, the second surface in the central portion) is flat, and is used as a lead welding surface. The thickness of central portion 4 is denoted by T_{c}, and the thickness of collar portion 5 is denoted by T_{b}. Thickness t_{c2} of second metal layer 2b in central portion 4 is greater than thickness t_{b2} of second metal layer 2b in collar portion 5. Thickness t_{c2} of second metal layer 2b in central portion 4 is greater than thickness t_{c1} of first metal layer 2a in the central portion.

As discussed above, sealing body 1 obtains the structure shown in FIG. 1 by molding a plate-shaped clad material, so that the rigidity of the second metal constituting second metal layer 2b is lower than that of the first metal constituting first metal layer 2a. The higher rigidity of the first metal can suppress the deformation of sealing body 1 when the opening of the battery case and sealing body 1 are caulked and sealed. The lower rigidity of the second metal allows sealing body 1 to be easily molded and allows the lead to be easily welded.

### (Cylindrical Battery)

A cylindrical battery in accordance with the exemplary embodiment of the present invention includes a bottomed cylindrical battery case having an opening, an electrode group and electrolyte that are accommodated in the battery case, and a sealing body for sealing the opening. The type of the cylindrical battery is not particularly limited, but may be a primary battery or a secondary battery. As components other than the sealing body, known components can be employed in accordance with the type of the battery.

Hereinafter, taking a lithium-ion secondary battery as an example, components other than the sealing body of the cylindrical battery are specifically described. However, the cylindrical battery of the present exemplary embodiment is not limited to the lithium-ion secondary battery.

### (Battery Case)

The battery case has a bottomed cylindrical shape, and includes an opening. The opening of the battery case is sealed by the sealing body. The electrode group and electrolyte are accommodated in the battery case.

It is preferable that the battery case is a metal can. As the material of the battery case, aluminum, aluminum alloy, iron, or iron alloy (including stainless steel) can be employed, for example. The battery case may be plated as necessary. The material of the battery case can be appropriately selected in accordance with the polarity of the battery case.

The size of the battery case can be appropriately selected in accordance with the application. In a battery having a small diameter after assembling, the outer diameter of the battery case (namely, outer diameter of the battery) is preferably 10 mm or less, or may be 6 mm or less. In such a battery, by using the above-mentioned sealing body, the effect of the present invention such as a high strength of the sealing body and a high weldability of the lead to the sealing body is easily exerted.

### (Electrode Group)

The electrode group includes a positive electrode, a negative electrode, and a separator interposed between the positive electrode and the negative electrode. The type of the electrode group is not particularly limited, but may be a winding-type electrode group or a lamination-type electrode group. The positive electrode solely needs to include a positive-electrode active material, and generally includes a positive-electrode current collector, and a positive-electrode active material layer adhering to a surface of the positive-electrode current collector. The negative electrode solely needs to include a negative-electrode active material, and may include a negative-electrode current collector, and a negative-electrode active material layer adhering to a surface of the negative-electrode current collector.

As each of the positive-electrode current collector and negative-electrode current collector, a metal foil or a metal porous body is employed. As the metal material of the positive-electrode current collector, aluminum or aluminum alloy is employed, for example. As the metal material of the negative-electrode current collector, copper or copper alloy is employed, for example.

As the positive-electrode active material, a material known as the positive-electrode active material of a lithium-ion secondary battery can be employed without particular limitation. As the positive-electrode active material, a lithium-containing transition metal oxide is employed. Examples of the lithium-containing transition metal oxide include a lithium cobalt oxide, a lithium nickel oxide, a lithium manganese oxide, and a lithium-containing composite oxide that is obtained by replacing a part of Co, Ni, or Mn with another element in these compounds.

The positive-electrode active material layer includes a positive-electrode active material, and can include a binder and/or a conductive agent as necessary. As each of the binder and the conductive agent, a material used for a lithium-ion secondary battery can be employed without particular limitation. As the binder, polyvinylidene fluoride or styrene-butadiene rubber is employed, for example. As the conductive agent, carbon black, graphite, or carbon fiber is employed, for example.

As the negative-electrode active material, a material known as the negative-electrode active material of a lithium-ion secondary battery can be employed without particular limitation. As the negative-electrode active material, a carbon material or the like capable of absorbing and desorbing lithium ions is preferable. As such a carbon material, a graphite material (natural graphite or artificial graphite) or an amorphous carbon material is employed, for example.

The negative-electrode active material layer includes a negative-electrode active material, and can include a binder and/or a thickener as necessary, and further may include a conductive agent. The binder and the conductive agent can be appropriately selected from the materials shown in the description of the positive-electrode active material layer. As the thickener, a material used for a lithium-ion secondary battery can be employed without particular limitation. As a specific example of the thickener, carboxymethyl cellulose or its salt can be employed.

Each of the positive electrode and negative electrode can be produced in the following steps:
coating a surface of a collector with a mixture slurry containing a dispersion medium and a component of an active material layer such as an active material;
drying them; and
compressing them in the thickness direction.
   As the dispersion medium, water, an organic solvent such as N-methyl-2-pyrrolidone, or a mixed solvent of them can be employed.

As the separator, a material used for a lithium-ion secondary battery can be employed without particular limitation. For example, a microporous film or nonwoven fabric made of a resin is employed. As the resin constituting the microporous film or nonwoven fabric, polypropylene, polyethylene, polyamide, or polyamide-imide is employed, for example.

### (Electrolyte)

As the electrolyte, a non-aqueous electrolyte is employed which includes a non-aqueous solvent and a solute dissolved in the non-aqueous solvent. As the solute, lithium salt used for a lithium-ion secondary battery can be employed without particular limitation. Specific examples of the lithium salt include lithium hexafluorophosphate and lithium tetrafluoroborate.

As the non-aqueous solvent, a non-aqueous solvent used for a lithium-ion secondary battery can be employed without particular limitation. Specific examples of the non-aqueous solvent include polypropylene carbonate, ethylene carbonate, dimethyl carbonate, and diethyl carbonate.

### (Others)

The positive electrode (or negative electrode) included in the electrode group is electrically connected to the battery case or sealing body via a lead. In other words, one end of the lead is connected to an electrode (positive electrode or negative electrode), and the other end is connected to the battery case or sealing body. Since the volume in the battery case is small, preferably, one end of the lead to be electrically connected to the sealing body is connected to the electrode on the inner periphery side of the electrode group, and one end of the lead to be electrically connected to the battery case is connected to the electrode in the outermost part possible (outermost periphery or the like) of the electrode group.

The polarities of the battery case and sealing body can be optionally determined. In order to effectively use the volume in the battery case, preferably, the electrode group is formed so that the electrode having the same polarity as that of the battery case is disposed in the outermost part possible (outermost periphery or the like), and the other end of the lead pulled out of the electrode is connected to the inner wall of the battery case. At this time, it is advantageous that an active material layer is not formed but a collector is exposed on the outermost periphery of the electrode group. The terminal portion of the sealing body may be either of an external positive electrode terminal and an external negative electrode terminal. Since the sealing body has a projecting shape, however, it is preferable that the lead pulled out of the positive electrode is connected to the lead welding surface on the second surface side of the sealing body, and the terminal portion is used as the external positive electrode terminal. In this case, the battery case is connected to the negative electrode, and is used as the external negative electrode terminal.

Each of the sealing body and the battery case can be electrically connected to the lead by welding. When the battery has a small diameter, in order to increase the volume occupied by the sealing body as much as possible, it is preferable that the lead is connected to the battery case via the inner wall of the battery case.

As the material of a positive electrode lead, for example, metal such as aluminum, titanium, or nickel, or its alloy can be used. As the material of a negative electrode lead, for example, metal such as copper or nickel, or its alloy can be used. The shape of each lead is not particularly limited, but a wire shape or sheet shape (or ribbon shape) can be used, for example.

In the cylindrical battery, the opening of the battery case is sealed with the above-mentioned sealing body.

In the battery including a sealing body, generally, a safety valve is disposed in the sealing body in preparation for increase in inner pressure in the battery. When gas is generated in the battery in a high-temperature environment and the safety valve is repeatedly opened, the electrolyte is apt to leak. In the present exemplary embodiment, the sealing body is used, so that such leak of the electrolyte can be suppressed and the sealability of the battery can be further enhanced.

The sealing of the opening in the battery case by the sealing body can be achieved by a known method. For example, the opening in the battery case and the sealing body are caulked and sealed via a gasket. The caulking and sealing can be performed by bending the opening end of the battery case inward toward the sealing body via the gasket. Employing the caulking and sealing can produce the following advantage: even if the inner pressure in the battery increases, the sealing body comes off, the internal pressure is released, and hence the safety is kept.

The gasket is interposed between the opening (specifically, opening end) of the battery case and the rim of the sealing body (mainly the collar portion of the sealing body), and has a function of insulating them from each other and keeping the sealability of the battery. The shape of the gasket is not particularly limited, but it is preferable to employ a ring shape so as to cover the rim of the sealing body. The gasket is made of an insulating material such as a synthetic resin. From the viewpoint of further enhancing the sealability of the battery, a sealing agent or the like may be disposed between the gasket and the sealing body and/or battery case as necessary.

In the assembled battery, an insulating layer may be disposed in a region (outside the battery) where the battery case is close to the sealing body via the gasket. When the sealing is performed by bending the opening end of the battery case inward toward the sealing body via the gasket, for example, an insulating layer may be disposed on at least the outer surface of the bent opening end and a periphery of the outer surface.

The cylindrical battery can be manufactured by accommodating the electrode group and electrolyte in the battery case and sealing the opening of the battery case with the sealing body.

An insulating ring or the like can be disposed between the top of the electrode group and the sealing body. The other end of the lead pulled out of the electrode group is connected to the lead welding surface of the sealing body in the state where the other end is passed through the hole of the insulating ring.

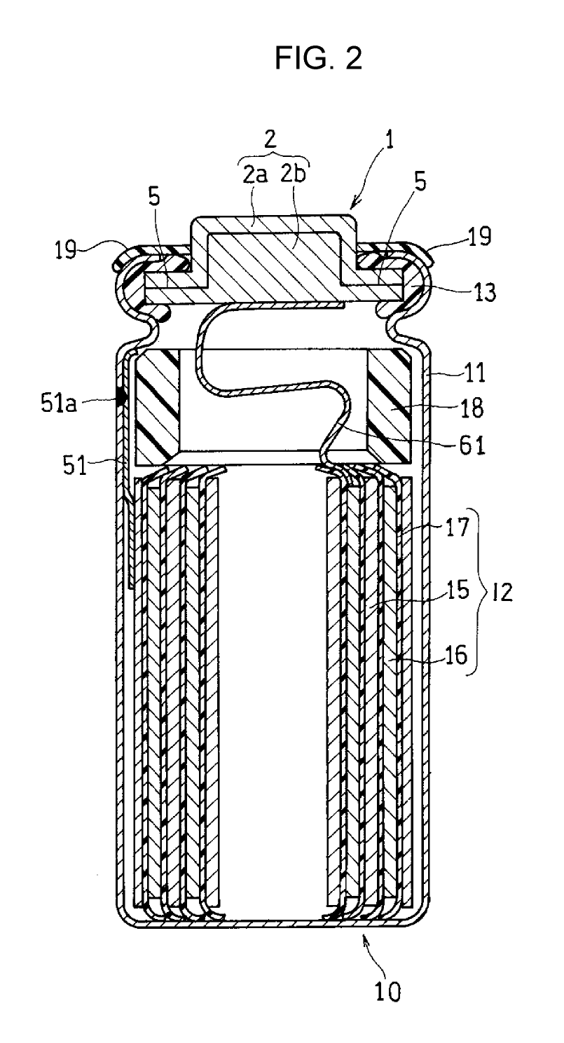

FIG. 2 is a schematic vertical sectional view of a cylindrical battery in accordance with the exemplary embodiment of the present invention. The cylindrical battery of FIG. 2 includes the sealing body of FIG. 1.

Cylindrical battery 10 includes: bottomed cylindrical battery case 11 having an opening; winding-type electrode group 12 and an electrolyte (not shown) that are accommodated in battery case 11; and sealing body 1 for sealing the opening in battery case 11. Electrode group 12 includes negative electrode 15, positive electrode 16, and separator 17 interposed between negative electrode 15 and positive electrode 16. Electrode group 12 is impregnated with the electrolyte.

Ring-shaped insulating gasket 13 is disposed at a rim of sealing body 1 so as to cover collar portion 5. Then, the opening end of battery case 11 is bent inward via gasket 13, and is caulked in the rim of sealing body 1, thereby sealing battery case 11.

A space is formed between the upper end surface (top surface) of electrode group 12 and the second surface of sealing body 1. Insulating ring 18 is disposed in this space, and regulates the contact between electrode group 12 and sealing body 1.

One end of ribbon-shaped positive electrode lead 61 is connected, by welding or the like, to positive electrode 16 (an exposed portion of the positive-electrode current collector) on a more inner peripheral side of winding-type electrode group 12. The other end is connected to a lead welding surface of sealing body 1 in the state where the other end is passed through a hole formed in the center of insulating ring 18. In other words, positive electrode 16 is electrically connected to sealing body 1 via positive electrode lead 61, and sealing body 1 has a function as an external positive electrode terminal.

In the outermost periphery of winding-type electrode group 12, negative-electrode active material layer is formed on only one surface of negative electrode 15, and a negative-electrode current collector is exposed on the other surface. The exposed negative-electrode current collector faces the inner wall of battery case 11. One end of negative electrode lead 51 is connected to the negative-electrode current collector in the outermost periphery by welding or the like, and the other end of negative electrode lead 51 is connected to the inner wall of battery case 11 at welding point 51a. In other words, negative electrode 15 is electrically connected to battery case 11 via negative electrode lead 51, and battery case 11 has a function as an external negative electrode terminal.

Doughnut-shaped insulating layer 19 made of an electric insulating material is disposed so as to cover the outer surface of the bent opening end of battery case 11 and the surface of the gasket around the outer surface. Near the opening of battery case 11, sealing body 1 and battery case 11 having opposite polarities are more certainly separated from each other via insulating layer 19 when viewed from the outside of the battery, and an external short circuit can be effectively suppressed.

### INDUSTRIAL APPLICABILITY

A sealing body in accordance with an exemplary embodiment of the present invention has a simple structure, has a high strength, and allows easy welding of a lead. Therefore, the sealing body is appropriate for a cylindrical battery, especially for a cylindrical battery having a small diameter. A cylindrical battery having a small diameter can be appropriately used as a power source of various electronic devices, especially as a power source of various portable electronic devices requiring a small-sized power source. For example, the portable electronic devices include glasses (3D glasses or the like), a hearing aid, a stylus pen, and a wearable terminal.

1. A sealing body for cylindrical batteries, comprising a clad material having a first surface and a second surface opposite to the first surface, wherein
the clad material includes:
a first metal layer made of a first metal on the first surface side; and
a second metal layer made of a second metal on the second surface side,
the clad material is formed so as to include a central portion having a projecting terminal portion, and a collar portion disposed on a rim of the central portion integrally with the central portion,
the clad material includes the terminal portion on the first surface side, and a lead welding surface on the second surface side, and
the first metal has a rigidity higher than a rigidity of the second metal.

2. The sealing body for cylindrical batteries according to claim 1, wherein
the first metal includes a simple metal or an alloy containing at least one metal selected from a group consisting of nickel, iron, and copper, and
the second metal includes aluminum or an aluminum alloy.

3. The sealing body for cylindrical batteries according to claim 1, wherein
a thickness of the second metal layer in the central portion is greater than a thickness of the second metal layer in the collar portion.

4. The sealing body for cylindrical batteries according to claim 3, wherein
the second metal has a melting point and/or a resistivity lower than a melting point and/or a resistivity of the first metal.

5. The sealing body for cylindrical batteries according to claim 3, wherein
a proportion of the thickness of the second metal layer in the central portion to a thickness of the central portion is 30% to 95% inclusive.

6. The sealing body for cylindrical batteries according to claim 3, wherein
a proportion of the thickness of the second metal layer in the collar portion to a thickness of the collar portion is 5% to 70% inclusive.

7. The sealing body for cylindrical batteries according to claim 3, wherein
an average diameter of an outer periphery of the collar portion is 10 mm or less.

8. The sealing body for cylindrical batteries according to claim 3, wherein
the second surface includes a flat surface.

9. A cylindrical battery comprising:
a bottomed cylindrical battery case having an opening;
an electrode group and an electrolyte that are accommodated in the battery case; and
a sealing body for sealing the opening,
wherein the sealing body includes a clad material having a first surface and a second surface opposite to the first surface,
wherein the clad material includes:
a first metal layer made of a first metal on the first surface side; and
a second metal layer made of a second metal on the second surface side,
wherein the clad material is formed so as to include a central portion having a projecting terminal portion, and a collar portion disposed on a rim of the central portion integrally with the central portion,
wherein the clad material includes the terminal portion on the first surface side, and a lead welding surface on the second surface side, and
wherein the first metal has a rigidity higher than a rigidity of the second metal.

10. The cylindrical battery according to claim 9, having an outer diameter of 10 mm or less.

11. The sealing body for cylindrical batteries according to claim 9 wherein a thickness of the second metal layer in the central portion is greater than a thickness of the second metal layer in the collar portion.

12. The sealing body for cylindrical batteries according to claim 11, wherein the second metal has a melting point and/or a resistivity lower than a melting point and/or a resistivity of the first metal.

13. The sealing body for cylindrical batteries according to claim 11, wherein a proportion of the thickness of the second metal layer in the central portion to a thickness of the central portion is 30% to 95% inclusive.

14. The sealing body for cylindrical batteries according to claim 11, wherein a proportion of the thickness of the second metal layer in the collar portion to a thickness of the collar portion is 5% to 70% inclusive.

15. The sealing body for cylindrical batteries according to claim 11, wherein an average diameter of an outer periphery of the collar portion is 10 mm or less.

16. The sealing body for cylindrical batteries according to claim 11, wherein the second surface includes a flat surface.
